(19) United States
(12) Patent Application Publication
(10) Pub. No.: US 2004/0128582 A1
(43) Pub. Date: Jul. 1, 2004

(54) Method and apparatus for dynamic bad disk sector recovery

(76) Inventor: Ching-Hai Chou, Taipei (TW)

Correspondence Address: PERKINS COIE LLP, PATENT-SEA, P.O. BOX 1247, SEATTLE, WA, 98111-1247, US

(21) Appl. No.: 10/705,809

(22) Filed: Oct. 6, 2003

Related U.S. Application Data
(60) Provisional application No. 60/424,153, filed on Nov. 6, 2002.

(51) Int. Cl. H04L 1/22

(52) U.S. Cl. 714/5

(57) ABSTRACT

An automatic process for recovering bad disk sectors by providing improved error handling and recovery of data, maintains disk data consistency, and relocates data structures from bad disk sectors. A bad-sector-mapping (BSM) table to correspond to a reserve sector space in the disk. In one embodiment, the BSM includes N entries for N reserved sectors in the bottom space of a disk. The content of each table entry contains two fields: a header and an address. There are three flag bits being defined in a head field, with each flag bit being used to specify status of how a bad sector occurred. The address field stores a disk offset for identifying the location of data stored in the disk. The last entry of the map table, or the last n+1 entry, is a checksum entry.

### CROSS-REFERENCE TO RELATED APPLICATION(S)

This application claims priority under 35 U.S.C. § 119 to U.S. Provisional Application No. 60/424,153 filed Nov. 6, 2002.

### TECHNICAL FIELD

The present invention relates to disk operations concerning error handling and data recovery of disk storage media, and more particularly, to a mechanism for dynamic bad disk sector recovery.

### BACKGROUND

As the storage space of modern disk drives increases, the occurrence of bad disk sectors also increases. In disk drive technology, there always exists a need for a mechanism to relocate bad disk sectors and recover the data to other normal functioning sectors in disk. The mechanism must have a mapping table to record the correspondence relationship of a reserve sector and its replaced bad sector. Most existing bad-sector-recovery mechanisms consider the relocation of an I/O failure block to reserve disk space in the same disk. The replacement of bad sectors block by block will consume disk space rather fast. To ease the situation of fast consumption of disk space, we can extract out only those sectors that need to be replaced in the block, so that we only need to deal with bad sectors only.

When a sector being written to is found to be bad, then the mechanism must map the bad sector to an unused reserve sector. However, if data stored in the bad sector is invalid, then a read operation to the bad sector may lead to the loss of the data. In such a case, the reserve sector should be labeled as also invalid to avoid the misuse of its data. The invalid status can only be cleared when the data stored in the sector has been completely updated by the system.

Many large data storage systems adopt a RAID configured approach to improve the efficiency of I/O performance and data protection of mass disk storage media. When a disk sector is ruined, the data stored in the sector can be recovered from the redundant data according to RAID levels, such as RAID 1 mirroring and RAID 5 striping with parity.

Dynamic bad disk sector recovery during runtime is complex when dealing with the problems encountered in real applications. Many bad disk sector recovery methods presented in the prior art are rather simple. However, a simple bad disk sector recovery method may encounter difficulties in real applications. For example, in a real application, a reserve sector for replacing a bad sector itself may be bad or damaged also. When this is the case, the reserve section needs to be labeled as damaged. At the same time, another reserve sector needs to be found to rebuild the data in the bad sector. However, if the data was already lost, then the new reserve sector must be labeled as invalid to avoid the misuse of data in the sector.

Further, relocating bad sectors and recovering data of bad sectors associated with RAID configured storage systems in real applications require consideration of data consistency in dynamic bad disk sector recovery. A more sophisticated bad disk sector recovery method that employs flags to distinguish and handle complex situations is needed.

It would be desirable, therefore, to provide a mechanism that can dynamically recover bad disk sectors of data with non-RAID and RAID levels while keeping a steady file system operation and maintaining data consistency of a storage system during runtime.

### BRIEF DESCRIPTION OF THE DRAWINGS

FIG. 1 illustrates the structure of a BSM table and its one-to-one corresponding reserve sector in disk space according to a preferred embodiment of the present invention.

FIG. 2A is a flowchart illustrating the procedure of how the system deals with an input/output request.

FIGS. 2B and 2B-1 are flowcharts illustrating the procedure of how to associate a reserve sector to the BSM table.

FIG. 2C is a flowchart illustrating the procedure of how to recover a bad sector using the structure of BSM and reserve sector.

FIG. 3 is a flowchart illustrating the procedure for updating RAID parity block according to a preferred embodiment of the present invention.

### DETAILED DESCRIPTION

The present invention provides an automatic process for recovering bad disk sectors, where the disk storage media may be non-RAID or RAID configured. The present invention provides improved error handling and recovery of data, maintains disk data consistency, and relocates data structures from bad disk sectors.

The present invention first creates a bad-sector-mapping (BSM) table to correspond to a reserve sector space in the disk. In one embodiment, the BSM includes N entries for N reserved sectors in the bottom space of a disk. The content of each table entry contains two fields: a header and an address. There are three flag bits being defined in a head field, with each flag bit being used to specify status of how a bad sector occurred. The address field stores a disk offset for identifying the location of data stored in the disk. The last entry of the map table, or the last n+1 entry, is a checksum entry.

The first flag bit is used to flag on or off the status of damage. When the damage bit of an entry is set “on”, then its corresponding reserve sector cannot be used. The second flag bit is used to flag on or off the status of invalidity. When the “invalid bit” of an entry is set “on”, then the data stored in the corresponding reserve sector cannot be used. The third flag bit is used to flag on or off the status of temporary invalidity. When the temporary invalidity bit of an entry is set “on”, then the disk sector (as indicated by its offset address) is not necessarily a bad sector, and an update operation will release the BSM entry of this disk sector.

In accordance with one aspect of the present invention, when a read/write request is intercepted, the bad sector recovery mechanism of the present invention starts by checking if the requested block contains bad sectors. If no bad sectors are found, the normal operational process for the I/O request is performed. If bad sectors are found, a bad sector recovery process is performed, wherein the bad sector data is rebuilt (see below with respect to box 222) and the bad sector mapping table structure is updated.

In accordance with another aspect of the present invention, the process for the association of a reserve sector to a bad sector begins by checking if the damage flag of a bad sector recorded in the BSM table has been set on. Then, if the damage flag is off, the process continues in performing the read/write operation, while updating the status of flags according to different situations encountered during the read/write operation.

In accordance with yet another aspect of the present invention, the process for inserting a new entry to the BSM table of the present invention begins by constructing a new BSM entry to replace the newly found bad sector, and update the corresponding reserved sector if nessary.

In accordance with a further aspect of the present invention, the process for updating RAID configured data of the present invention consists of generating new data for the parity block, writing the parity block to disk, and updating the bad sector table entries if necessary.

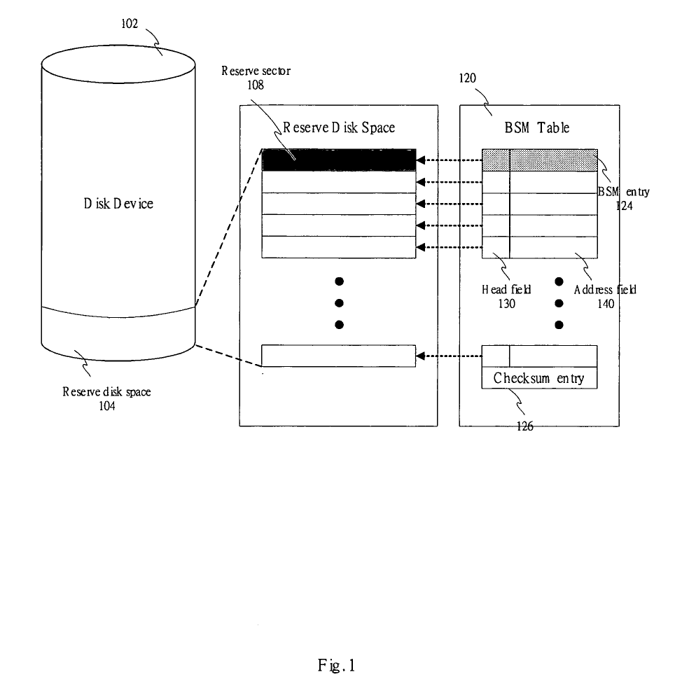

FIG. 1 illustrates in schematic form the use of the BSM table of the present invention in conjunction with a disk storage device. Specifically, a disk storage device 102 has reserve disk space 104. The disk storage device 102 may be a RAID disk, and more particularly, be a mirrored RAID-1 or a striped RAID-5 storage. The reserve disk space 104 is divided into reserve sectors 108. The size of the reserve sectors 108 is variable in various implementations. However, there should be several discrete reserve sectors 108 in the reserve disk space 104. A BSM table 120 is used to track the status and condition of the reserve sectors 108. The BSM table 120 includes a BSM entry 124 that corresponds to each of the reserve sectors 108. Therefore, in one embodiment, there are the same number of BSM entries 124 as there are reserve sectors 108. Each BSM entry 124 contains two fields: a header field 130 and an address field 140. Additionally, an entry in the BSM table 120 is used as a check sum entry 126. The check sum entry is used to insure data integrity of the BSM table 120.

As noted above, the header field 130 includes 3 flag bits, with each flag bit being used to specify the status of how a bad sector occurred. The address field 140 stores a disk offset for identifying the location of data stored in the disk 102.

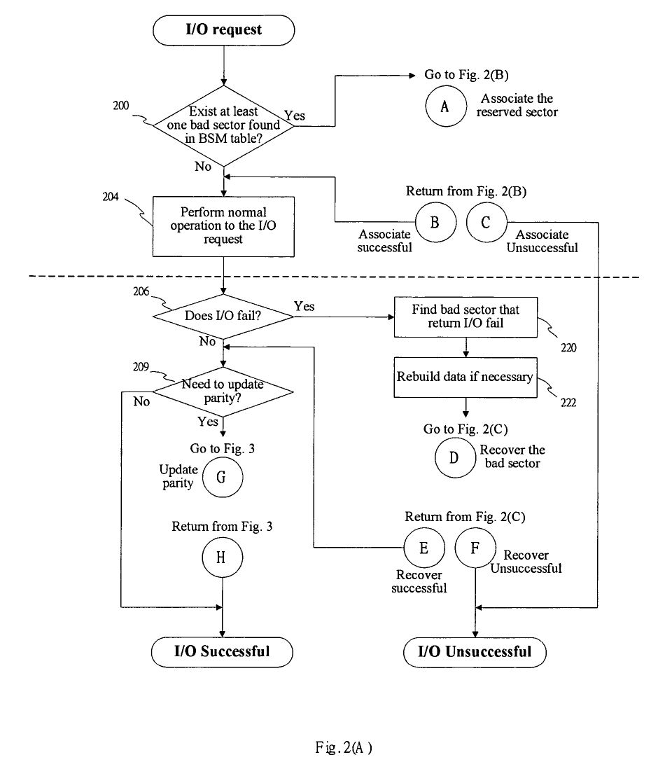

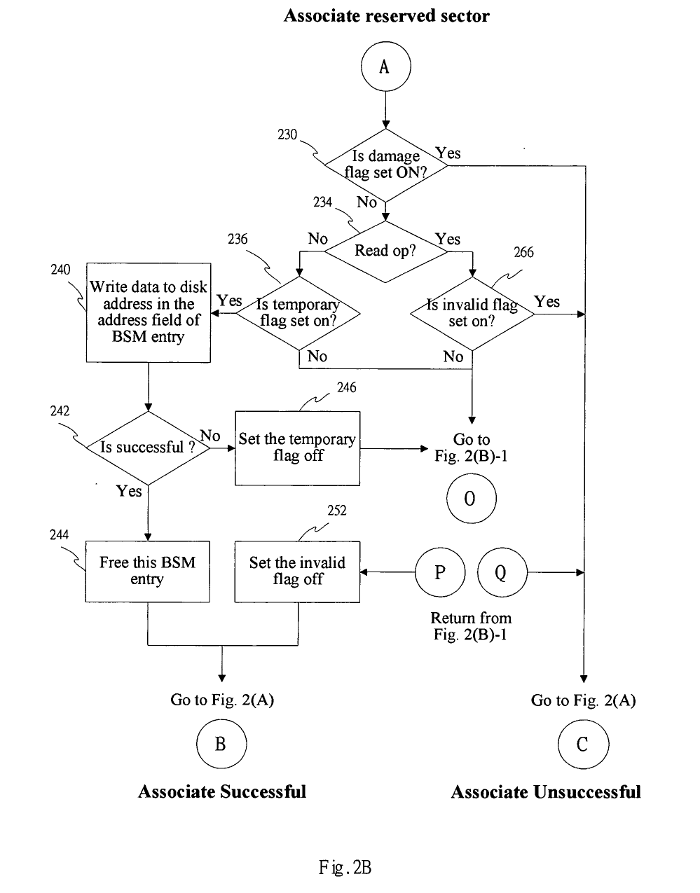

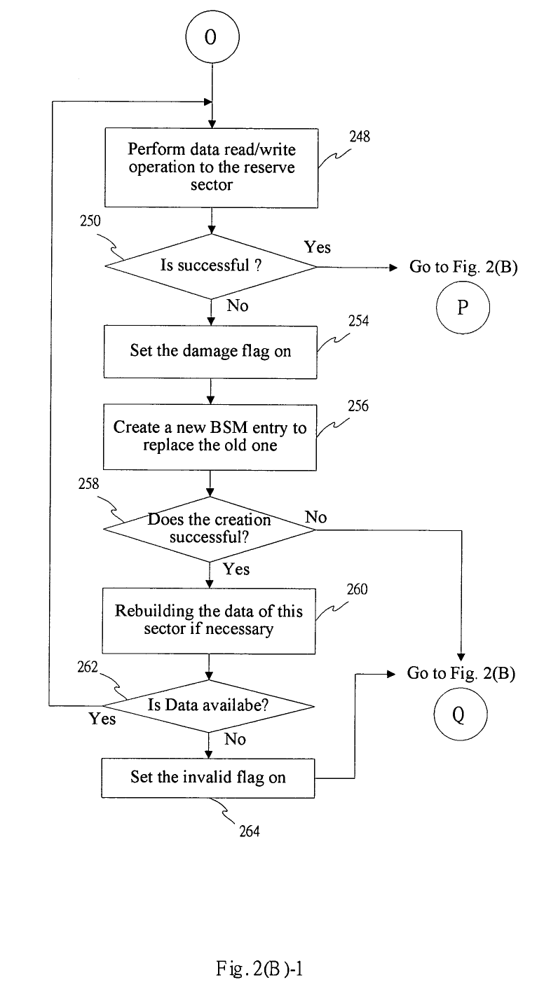

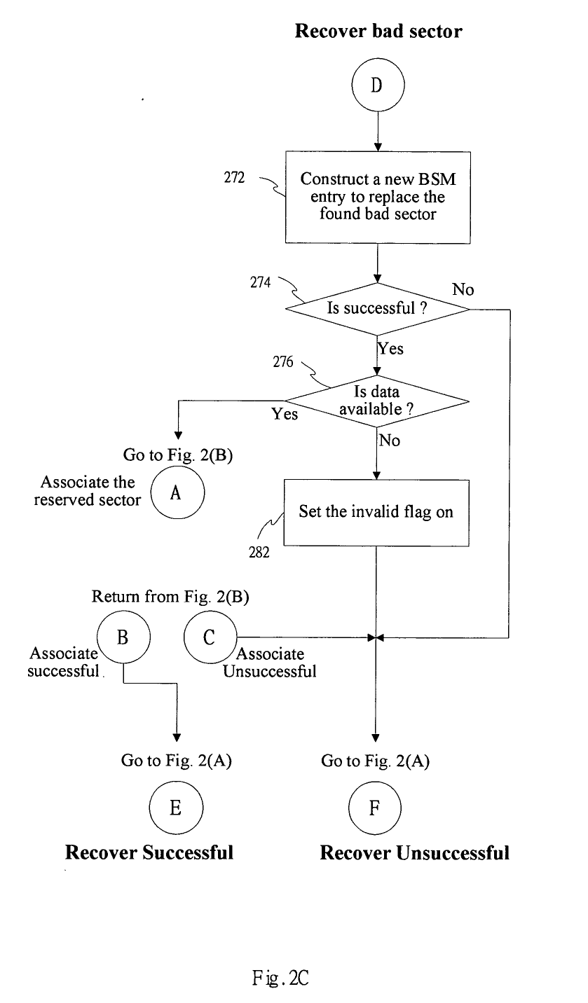

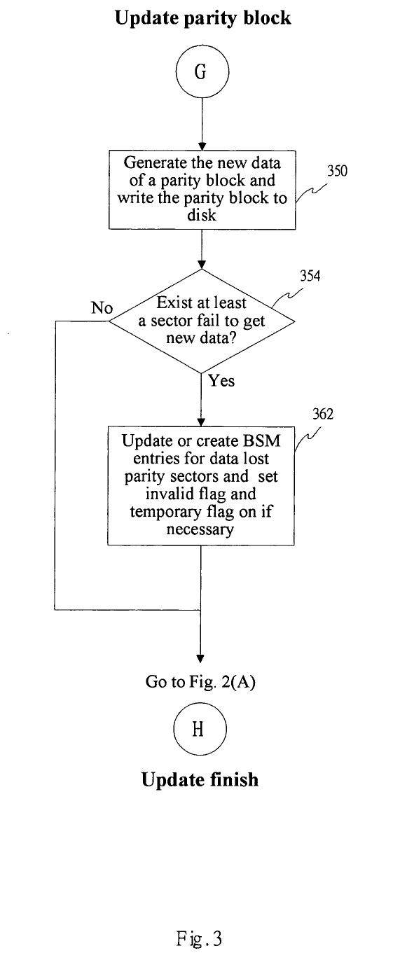

Turning next to FIG. 2A, a flow chart describing how the present invention processes an input/output (I/O) request is shown. At box 200, a determination is made as to whether or not there is at least one bad sector found in the BSM table 120. If there is, then a reserve sector 108 is associated as will be described in FIG. 2B. However, if there are no bad sectors in the BSM table 120, normal I/O request processing is performed at box 204. Next, at box 206, a determination is made as to whether the I/O request has been handled correctly. If the I/O request does not fail, then at box 209, a determination is made as to whether or not the parity needs to be updated. If so, this process is further described in FIG. 3 below. However, if the parity does not need to be updated, then the I/O request has been deemed successful. For a RAID-5 system, parity generally only needs to be updated during a write operation, but not a read operation.

However, if at step 206 the I/O request is deemed to have failed, then at step 220, the bad sector that returns the I/O failure indication is identified. Then, at box 222, the bad sector data is rebuilt if necessary. Further, the bad sector must be recovered, which is further described in FIG. 2C. As used herein, rebuilding bad sector data means the process of recalculating the data (if the storage system has redundant or parity data, such like RAID 1 and RAID 5). For example, a write operation does not need to rebuild data, because a write operation already has the correct data which is updated. If it is a read operation and the RAID type does not support the data rebuild, the data will be unavailable.

The term “recovering a bad sector” means to construct a BSM entry to indicate this newly found bad sector address, then associate the “correct” data (it may be the rebuilt data) to it's corresponding reserved sector if data is available or to set the invalid flag on if data is unavailable (may be caused by rebuild failure. Thus, at box 222, if the RAID type supports data rebuilding, then the process tries to build (re-calculate) the data.

Turning to FIG. 2B, a process of associating the reserve sector is described. The term associating a reserve sector means to read/write the reserved sector according to the status field on its corresponding BSM entry. First, once a bad sector has been found in the BSM table 120, at box 230, the BSM entry 124 for the bad sector is examined. In particular, the header field 130 of the BSM entry 124 contains various flag bits, one of which is the “damage flag.” If the damage flag is set to “on”, as determined at box 230, then control of the process returns to FIG. 2A at node C. This indicates that the association process was unsuccessful and that the input/output request is ultimately unsuccessful. However, if the damage flag is not set to “on”, then a determination is made at box 234 as to whether or not the I/O request is a read operation. If yes, then at box 266, a determination is made as whether the “invalid flag” is set “on”. If yes, then control returns to node C of FIG. 2A and the I/O request is deemed unsuccessful. However, if the invalid flag is not set “on”, then control goes to FIGS. 2B-1.

Returning to box 234, if the I/O request is not a read operation, then at box 236, a check is made as to whether the “temporary flag” is set “on”. If the temporary flag is not set on, then control goes to FIGS. 2B-1. However, if the temporary flag is set on, then at box 240, the I/O request (already determined as a write operation) is processed by writing the data to the disk address in the address field of the BSM entry 124. If the write data process of box 240 is successful, as determined at box 242, then at box 244, the BSM entry 124 is “freed.” In other words, because the write operation is successful, which implies that the disk sector (indicated by the address field) is not a bad sector and the data is already updated, we need not keep this BSM entry. In this case, in one embodiment, the status field and address field are left blank to leave no disk sector reference it. However, if at box 242 the write process is not successful, then at box 246, the temporary flag of the BSM entry 124 is set to off and control goes to FIGS. 2B-1 at node 0. After box 244 where the BSM entry 124 has been freed, control returns to FIG. 2A at node B, which indicates that the association process is successful.

Turning to FIGS. 2B-1, at node 0, control is received from FIG. 2B as described above. At box 248, the I/O request is performed to the reserve sector 108 associated with the BSM table entry 124. At box 250, if the read/write operation is successful, then control goes back to node P of FIG. 2B and at box 252, the invalid flag is set to “off.” However, if at box 250, the read/write operation is unsuccessful, then the damage flag is set to “on” at box 254. Further, at box 256, a new BSM entry 124 is created that replaces the old BSM entry. Specifically, when control goes to box 256, this means that the original reserved sector is dead and another reserved sector is needed to replace it. Therefore, a non-referenced (unused) BSM entry is used to copy the address field from the old BSM entry, but set blank to the status field. This is similar to box 272 described below where a non-referenced (unused) BSM entry is identified for the “first” construction of a “newly found” bad sector).

At box 258, a determination is made as to whether or not the new BSM entry has been created successfully. In some situations, because the BSM table is finite in the number of BSM entries, it is possible to run out of BSM entries (implying no more reserved sectors), which would result in an unsuccessful creation of a BSM entry at box 258. If successful, then at box 260, the rebuilding of the data for the reserve sector 108 is performed if necessary.

Generally, it is necessary to rebuild the data depending upon the RAID type and whether it is a read/write operation. If control came from box 236 or 246, which means it came from write operation with correct data already, there is no need to rebuild data on box 260, and we can keep going to update (write) reserved sector at box 248. If control came from box 266, which means it came from read operation, rebuilding with the correct data should be done, if the RAID type supports redundant or parity data (RAID 1 and RAID 5). However, if the creation of the new BSM entry is determined at box 258 to be unsuccessful, then control goes to node Q of FIG. 2B which indicates that the association request was ultimately unsuccessful.

Further, at box 262, a determination is made as to whether or not data is available. Specifically, control goes to box 262 when there is a read/write operation to the original reserved sector, but it is now dead. Therefore, a new reserved section must be found to replace it and a decision should be made: should the data be written the new reserved sector or just set the invalid flag on to indicate the data is not available. Therefore, a decision is made as to whether the correct data is available to update to the reserved sector. The correct data depends on the read/write operation and the result of rebuilding the data. If control came from box 236 or 246, which means it came from a write operation with correct data already, there is no need to rebuild data at box 260, and we can keep going to update (write) the reserved sector at box 248. If control came from box 266, which means it came from read op, then the rebuilt data is used from box 260. If data is unavailable, then the process starting at box 248 is repeated. However, if data is unavailable, then at box 264, the invalid flag is set to on and the association request is unsuccessful.

Turning to FIG. 2C, the process of recovering the bad sector from node D of FIG. 2A is shown. First, at box 272, similar to the process at box 256, a new BSM entry is constructed to replace the found bad sector entry in the BSM table. If this creation of a new BSM entry at box 272 is deemed successful at 274, then a check is determined as to whether or not data is available at box 276 (similar to the process at box 262). If data is available at box 276, then control is returned to FIG. 2B at node A. However, if at box 276, data is not available, then at box 282, the invalid flag is set on. Further, at box 274, if the construction of the new BSM entry is unsuccessful, then control is returned to FIG. 2A at node F which indicates that the recovery process was deemed unsuccessful.

The process of updating the parity block from node G of FIG. 2A is described at FIG. 3. First, at box 350, the new data for the parity block is generated and is written to the disk. Then, at box 354, a determination is made as to whether or not a sector failed in order to get new data.

The process of box 350 can be split into two steps: one is new parity generation, the other is new parity writing. In the first step, for example, we need to read all corresponding data block on the strip to generate the new parity data block. If some sectors in the parity block cannot be calculated, which may be caused by bad sectors on data block reading, this implies that data has been lost on those sectors on parity disk. Still, those sectors are not bad sectors, so we need to use BSM entries to mark them as invalid (data unavailable), and to mark them as being in temporary use. When the process is successful in getting new data to update them in the future, if the the temporary flag is set on (see box 236), it is known that it was in temporary use before and it may not be a true bad sector. So, data is written to the disk address in the address field of the BSM entry (see box 240). If not, control returns to node H at FIG. 2A. However, if new data is failed to be obtained, then at box 362, the BSM table is updated by setting invalid flag and temporary flag on as necessary.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A computer-implemented method for managing disk bad sectors recovery comprising:
maintaining a bad-sector-mapping table containing a set of bad sector entries and a check sum field, wherein each bad sector entry has a one-to-one correspondance to a reserve sector and contains an address field for storing an address of a bad sector and a header field for indicating the current status of its associated reserve sector;
receiving I/O requests issued from an operating system;
identifying existed bad sectors from said bad-sector-mapping table;
associating the reserve sectors for the recovery;
finding the bad sectors that cause an I/O failure;
rebuilding the data that stored in said bad sector if needed;
recovering the bad sectors and constructing new bad-sector-table entries;
updating a parity block for RAID-type data recovery; and
reporting to said operating system if said I/O request is successful.

2. The method of claim 1, wherein the header field for each table entry further comprises three bits to flag three situations that may occurr to a bad sector within a disk block, including:
a bit to flag a sector pointed by its entry address whether it is a permanent damaged bad sector;
a bit to flag a sector pointed by its entry address whether it is an invalid bad sector; and
a bit to flag a sector pointed by its entry address whether it is a temporary bad sector.

3. The method of claim 1, wherein the step of updating the parity block further comprises:
calculating new data for the parity block;
writing new data to the parity block; and
updating the BSM table content for sectors with unavailable data.

4. The method of claim 3, wherein the step of updating the BSM table further comprises:
constructing new entries;
setting the temporary flag “on” for a sector in case when the sector was not listed in the previous BSM table;
setting the invalid flag on for a sector in a parity block in case when the sector's data cannot be used.

5. A method of managing disk bad sector recovery comprising:
maintaining a bad-sector-mapping table containing a set of bad sector entries and a check sum field, wherein each bad sector entry has a one-to-one correspondance to a reserve sector and contains an address field for storing an address of a bad sector and a header field for indicating the current status of its associated reserve sector;
checking an I/O request and an I/O result;
constructing a new bad-sector entry to the bad-sector-mapping table;
identifying bad sectors existing in the bad-sector-mapping table;
updating the content of the bad-sector-mapping table;
associating corresponding reserve sectors to the system operation;
finding bad sectors that causes an I/O failure;
constructing new entries into the BSM table;
rebuilding the bad sector data;
recovering the bad sector by using the reserved sector; and
storing the BSM table back to the disk device.

6. The system of claim 5, wherein the step of rebuilding data of a bad sector further comprises:
identifying the RAID type from the system-provided RAID configuration;
reading mirrored data from a RAID-1 or striped data RAID-5 from its corresponding disk sectors, otherwise indicating an unsuccessful rebuilding; and
constructing the striped data for the rebuilt sector in the case of a RAID-5.

7. The system of claim 5, wherein the step of recovering data of a bad sector further comprises:
constructing a new entry for the bad-sector-mapping table if allowed;
writing the data of the bad sector into its reserve sector in the case when the bad sector data is available; otherwise setting the invalid bit on in the case when the bad sector data is unavailable;
updating a check sum value for a check sum field of the bad-sector-mapping table; and
reporting whether the operation for recovery is successful or not.

8. The system of claim 5, wherein the step of associating a reserved sector indicated in the BSM table further comprises:
setting the ignore flag of a damage reserved sector on in the case when the damage flag is true;
freeing the invalid flag of the reserved sector if the association is for a write operation;
reporting unsuccessful association to the system if the invalid flag is set on;
writing data to a disk address indicated in the address field of the reserved sector in case when its corresponding temporary flag is set on;
erasing the corresponding entry by blanking its content;
reporting unsuccessful association if it is a successful writing; otherwise clearing its corresponding temporary flag;
performing read/write data to the reserve sector;
setting the damage flag on in case when read/write data to the reserve sector fails;
constructing a new entry to replace the old one in BSM table;
setting the invalid flag on in case when it is a read operation; and
reporting to the system whether the association is a successful one or not.
